(19) United States
(12) Patent Application Publication
(10) Pub. No.: US 2010/0306346 A1
(43) Pub. Date: Dec. 2, 2010

(54) METHOD AND APPARATUS FOR MODIFYING A DATA STREAM COMMUNICATION

(75) Inventors: Marko Anderson, Helsinki (FI); Marco Paglia, San Francisco, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/472,546

(22) Filed: May 27, 2009

(51) Int. Cl. G06F 15/16

(52) U.S. Cl. 709/220; 709/231

(57) ABSTRACT

In accordance with an example embodiment of the present invention, an apparatus comprises at least one processor and at least one memory. The at least one memory includes computer program code. Further, the at least one memory and the computer program code configured to, with the at least one processor, cause the apparatus to perform at least the following receive a user configuration related to a data stream from an electronic device; and share or unshare the data stream with the electronic device based at least in part on the user configuration.

### TECHNICAL FIELD

The present application relates generally to modifying a data stream communication.

### BACKGROUND

An electronic device may have a user interface to access contacts. Further, there may be different types of user interfaces. As such, the electronic device facilitates use of contacts for different types of user interfaces.

### SUMMARY

Various aspects of examples of the invention are set out in the claims.

According to a first aspect of the present invention, an apparatus comprises at least one processor and at least one memory. The at least one memory includes computer program code. Further, the at least one memory and the computer program code configured to, with the at least one processor, cause the apparatus to perform at least the following receive a user configuration related to a data stream from an electronic device; and share or unshare the data stream with the electronic device based at least in part on the user configuration.

According to a second aspect of the present invention, a method comprises receiving a user configuration related to a data stream from an electronic device and sharing the data stream with the electronic device based at least in part on the user configuration.

According to a third aspect of the present invention, an apparatus comprises at least one processor and at least one memory. The at least one memory includes computer program code. Further, the at least one memory and the computer program code configured to, with the at least one processor, cause the apparatus to perform at least the following transmit a user configuration related to a data stream; and receive the data stream based at least in part on the transmitted user configuration.

According to a fourth aspect of the present invention, a method comprises transmitting a user configuration related to a data stream from an electronic device and receiving the data stream based at least in part on the transmitted user configuration.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting a computer operating in accordance with an example embodiment of the invention;

FIG. 3 is a flow diagram illustrating an example method to share a data stream in accordance with an example embodiment of the invention;

FIG. 4 is a block diagram depicting an electronic device operating in accordance with an example embodiment of the invention;

FIG. 5 is a flow diagram illustrating an example method to receive a data stream in accordance with an example embodiment of the invention;

FIG. 6 is a screen view depicting an electronic device operating in accordance with an example embodiment; and

FIG. 7 is another screen view depicting electronic device operating in accordance with an example embodiment.

### DETAILED DESCRIPTION OF THE DRAWINGS

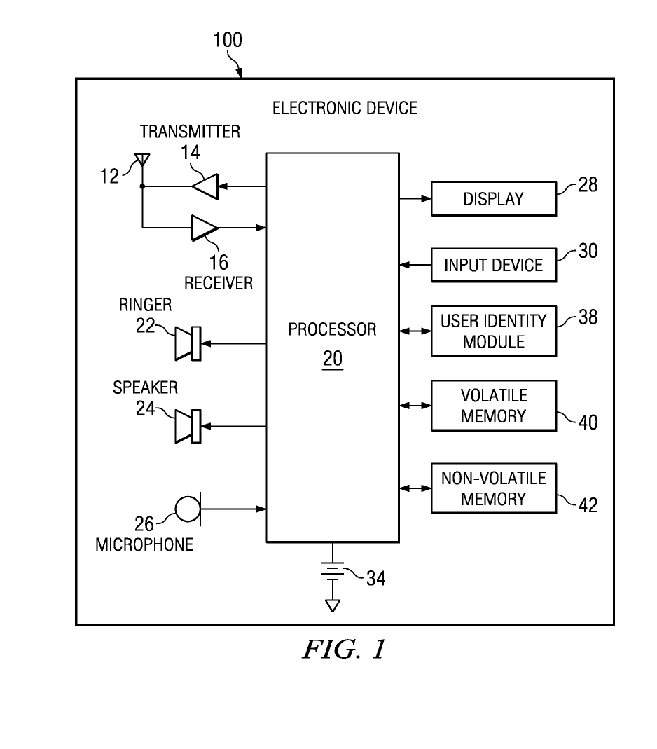

An example embodiment of the present invention and its potential advantages are understood by referring to FIGS. 1 through 7 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. In an example embodiment, the electronic device 100 may comprises multiple processors, such as processor 20. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, an input device 30 comprises a mouse, a touch screen interface, a pointer, and/or the like. In an embodiment, the one or more output devices of the user interface may be coupled to the processor 20. In an example embodiment, the display 28 is a touch screen, a liquid crystal display, an electronic ink, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

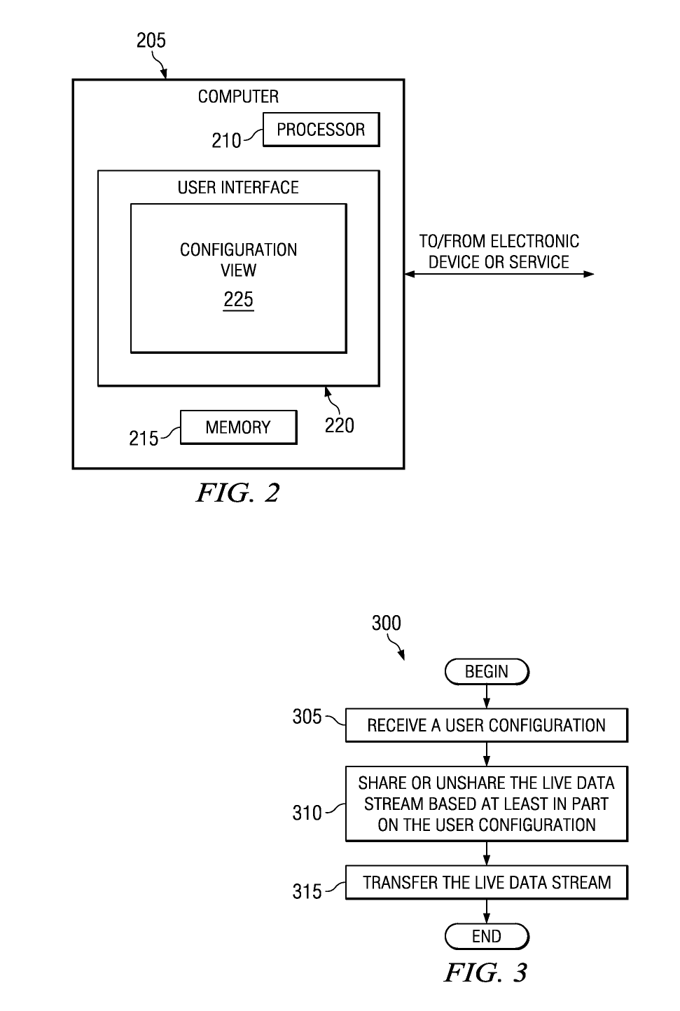

FIG. 2 is a block diagram depicting a computer 205 operating in accordance with an example embodiment of the invention.

In an example embodiment, the computer 205 comprises at least one processor 210, at least one memory 215 and/or a user interface 220. Further, the computer 205 may be in communication with an electronic device and/or a service. In an embodiment, the at least one processor 210 comprises at least one memory 215. The at least one memory 215 may comprise computer program code. In an example embodiment, the at least one memory 215 comprises computer program code. In an alternative embodiment, the at least one memory 215 may be separate from the at least one processor 210.

In an embodiment, the computer program code is configured to, with the at least one processor 210, cause the computer 205 to perform at least the following receive a user configuration related to a data stream from an electronic device; and share or unshare the data stream with the electronic device based at least in part on the user configuration. In an example embodiment, the user configuration is at least one of a tag or a flag associated with the data stream. For example, the computer 205 receives a flag, tag, and/or the like indicating to share or unshared the data stream from an electronic device, such as a mobile phone.

In an example embodiment, the at least one processor 210 is further configured to classify the data stream as shared or unshared based at least in part on the received user configuration. For example, the processor 210 configures the user configuration to share or unshared the data stream. In an example embodiment, the at least one processor 210 is configured to transfer the data stream to, for example, an electronic device or service. In an alternative embodiment, the at least one processor 210 is configured to receive a request for the data stream from the electronic device or service. In an example embodiment, the at least one processor 210 is further configured to share at least one additional data stream based at least in part on previously shared data streams. For example, the at least one processor 210 shares two or more data streams with a user of an electronic device. It should be understood that unshared data may or may not be displayed to a user or any related user.

In an example embodiment, the at least one processor 210 is configured to maintain a record for an unshared data stream in, for example, a database. In such a case, the at least one processor 210 is further configured to share recorded data from a second data stream previously unshared to, for example, a user. For example, if a user requests to share a data stream previously unshared data from the data stream is available to the user. A possible technical effect of one or more of the example embodiments disclosed herein is share data from a previously unshared data stream.

In an example embodiment, the at least one processor 210 is configured to share an event of the data stream. For example, the at least one processor 210 shares a news story with a user of an electronic device. In an example embodiment, the at least one processor 210 is further configured to classify the event of the data stream as shared or unshared based at least in part on the received user configuration.

In an example embodiment, the at least one processor 210 is configured to send a suggestion to a user based at least in part on previously shared data streams. For example, the at least one processor 210 sends advertisements, invitations to other streams, and/or the like. In an example embodiment, the user interface 220 of the computer 305 is configured to display one or more user configurations. Further, the user interface 220 may be configured to allow modification of the one or more user configurations.

FIG. 3 is a flow diagram illustrating an example method 300 to share a data stream in accordance with an example embodiment of the invention. Example method 300 may be performed by a computer, such as computer 205 of FIG. 2.

At 305, the user configuration is received. In an example embodiment, at least one processor, such as the at least one processor 210 of FIGURE, is configured to receive a user configuration related to a data stream from an electronic device. For example, the computer 205 receives a flag, tag, and/or the like indicating to share or unshared the data stream from an electronic device, such as a mobile phone. A technical effect of one or more of the example embodiments disclosed herein is receiving a flag, tag, and/or the like indicating to share or unshared a data stream.

At 310, the data stream is shared or unshared based at least in part on the user configured. In an example embodiment, the at least one processor is configured to share or unshare the data stream with the electronic device based at least in part on the received user configuration. For example, the at least one processor shares the data stream based on received a tag or a flag indicating to share the data stream.

At 315, the data stream is shared. In an example embodiment, the at least one processor is configured to transfer the data stream to, for example, an electronic device or service. For example, the at least one processor shares the data stream. The example method 300 ends. A possible technical effect of one or more of the example embodiments disclosed herein is sharing a data stream.

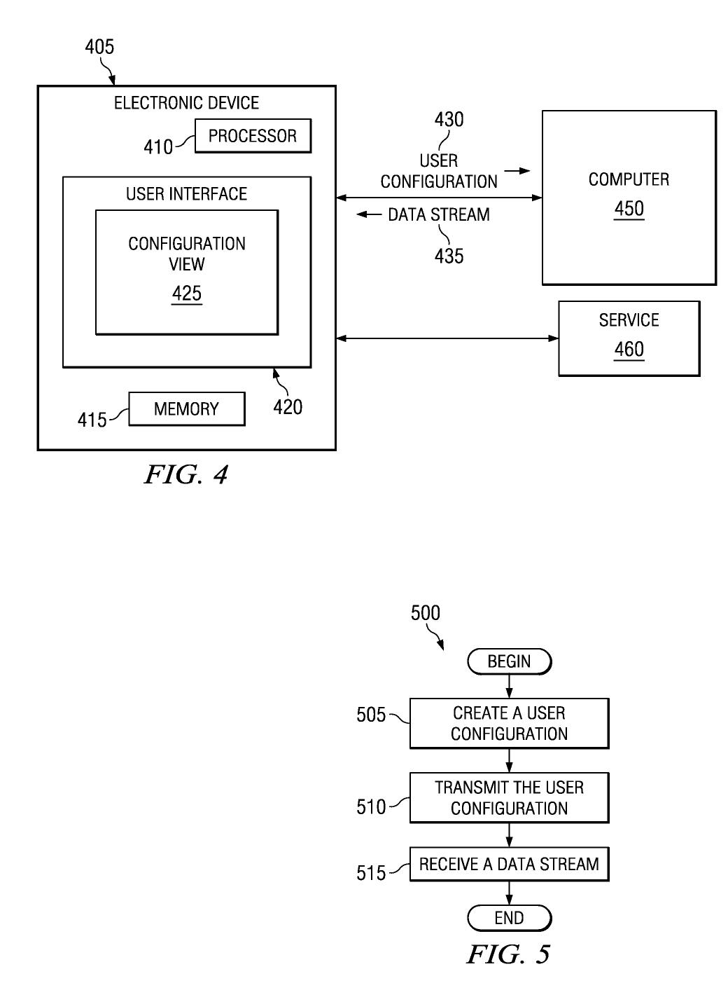

FIG. 4 is a block diagram depicting an electronic device 405 operating in accordance with an example embodiment of the invention. In an example embodiment, the electronic device 405 comprises at least one processor 410, at least one memory 415, a configuration view 425, and/or a user interface 420. In an example embodiment, the electronic device 405 may be in communication with a computer 450 or a service 460. In an example embodiment, computer 450 is similar to computer 205 of FIG. 2. In an alternative embodiment, computer 450 is different than computer 205 of FIG. 2.

In an example embodiment, the memory 415 comprises computer program code. In an embodiment, the computer program code is configured to, with the at least one processor 410, cause the electronic device 405 to perform at least the following transmit a user configuration 430 related to a data stream 435; and receive the data stream 435 based at least in part on the transmitted user configuration.

In an embodiment, the user interface 420 is configured to display a configuration view 425 to allow a user to interact, discover, revisit, manage, and/or the like one or more user configurations, such as user configuration 430. In an embodiment, the configuration view 425 allows the user to create a user configuration by flagging a data stream 435 as at least one of the following: as hidden, e.g. an exception, original status, and/or record the data stream 435 history. In such a case, the user is able to manipulate the events/activities in a temporal manner, the motivations of which may be related to, for example, changing privacy, interests, and interaction preferences over time.

In an example embodiment, the at least one processor 410 is configured to transmit a user configuration 430 related to a data stream 435. For example, the at least one processor 410 transmits a flag indicating to share or unshared the data stream 435 to a computer 450, a service 460, and/or the like. In an example embodiment, the at least one processor 410 is configured to receive the data stream 430 based at least in part on the user configuration 430. For example, the at least one processor 410 receives the data stream 435 based on a user configuration 430 having a flag indicating to share the data stream 435.

It should be understood that employing example embodiments of the invention are interaction in event/activity data streams, which is different than email. Further, the user has a more sophisticated and more temporal way to manipulate activities/events, rather than a binary and irreversible terminating/blocking action as in email.

In an example embodiment, the at least one processor 410 is configured to receive at least one additional data stream based at least in part on previously shared data streams. For example, the at least one processor 410 receives the data stream 435 based at least in part on a user preference, such as people, place, thing, and/or the like. In an example embodiment, the at least one processor 410 is configured to use various analytics, representations and interfaces, such as changing preferences over time, user preferences over time, personal content, private content, and/or the like. In an example embodiment, the at least one processor 410 is configured to receive a suggestion based at least in part on previously shared data streams. For example, the at least one processor 410 receives a suggestion, such as recommended data stream, an advertisement, or suggestion based on shared data streams for a user.

In an example embodiment, the service 460 is located on the computer 450. In an embodiment, the computer 450 includes a database of users. The service 460 may include the users as friends by accepting each other's invitations. In such a case, users who have accepted invitations will be a group of friends which can share or unshare different content. In an embodiment, content is generated based on the users' actions, rendering in the service 460. The content may be tracked by, for example, creating a metadata of the pages and/or the like.

In an embodiment, the content is displayed as at least one of the following: a list of most visited web pages, a list of most listened music, a list of most visited locations, a list of top contacts, and/or the like. Further, the content can be shared various ways to other users. If, for example, user A has visited a webpage, such as store.ovi.com, and has purchased a game, an application, and/or the like, the service 460 may display the purchase to other users in the group.

Consider the following example. The service 460 may provide showing user A's most visited webpage. In an embodiment, user A may delete, hide, and/or the like, the webpage from the most visited page as that will not give so much information to other users in the group and not give the benefit to them to do the same selection. Other users may receive information relating to what the user A has recently purchased in, for example, an online store. Thus, the service 460 provides the user a possibility to delete or unshare the listed content, if there is a match between same listed data e.g. one or more listed web addresses of users of the same group. In such a case, the sharable content can be shared between users in a more interesting way to users. Further, the computer 450, a second service, or a device accessing the service 460 may have list of content to be shared. In one or more embodiments the server, second service, or the device may recognize the list of shareable content. If one or more items in the list of content are common between two devices the service 460 may change the view automatically to show the match.

In an embodiment the service 460 may collect information how many times the same list of content item is shared. In an embodiment, the service 460 determines if a threshold number, such as three matches, has been made. In such a case, the service 460 may suggest to a user to review some fresh list of content item from a second user. Further the computer 450, second service, and/or device may collect current content to determine if the content has been recently provided to the user. In such a case, the computer 450, second service, and/or device may delete or hide the items due to the frequency of the sharing.

FIG. 5 is a flow diagram illustrating an example method 500 to receive a data stream in accordance with an example embodiment of the invention. Example method 500 may be performed by a computer, such as electronic device 405 of FIG. 4.

At 505, a user configuration is created. In an embodiment, a user interface, such as user interface 420 of FIG. 4, is configured to display a configuration view, such as configuration view 425 of FIG. 4. In an example embodiment, the configuration view allows the user to create a user configuration, such as user configuration 430 of FIG. 4, by flagging a data stream as at least one of the following: as hidden, e.g. an exception, original status, and/or record the data stream, such as data stream 435, history. In such a case, the user is able to manipulate the events/activities in a temporal manner, the motivations of which may be related to, for example, changing privacy, interests, and interaction preferences over time.

At 510, a user configuration is transmitted. In an example embodiment, at least one processor, such as the at least one processor 410 of FIG. 4, is configured to transmit the user configuration related to the data stream. For example, the at least one processor transmits a flag indicating to share or unshared the data stream to a computer, such as computer 450 of FIG. 4 or a service 460 of FIG. 4, and/or the like.

At 515, a data stream is received. In an example embodiment, the at least one processor is configured to receive the data stream based at least in part on the user configuration. For example, the at least one processor receives the data stream based on a user configuration having a flag indicating to share the data stream. The example method 500 ends.

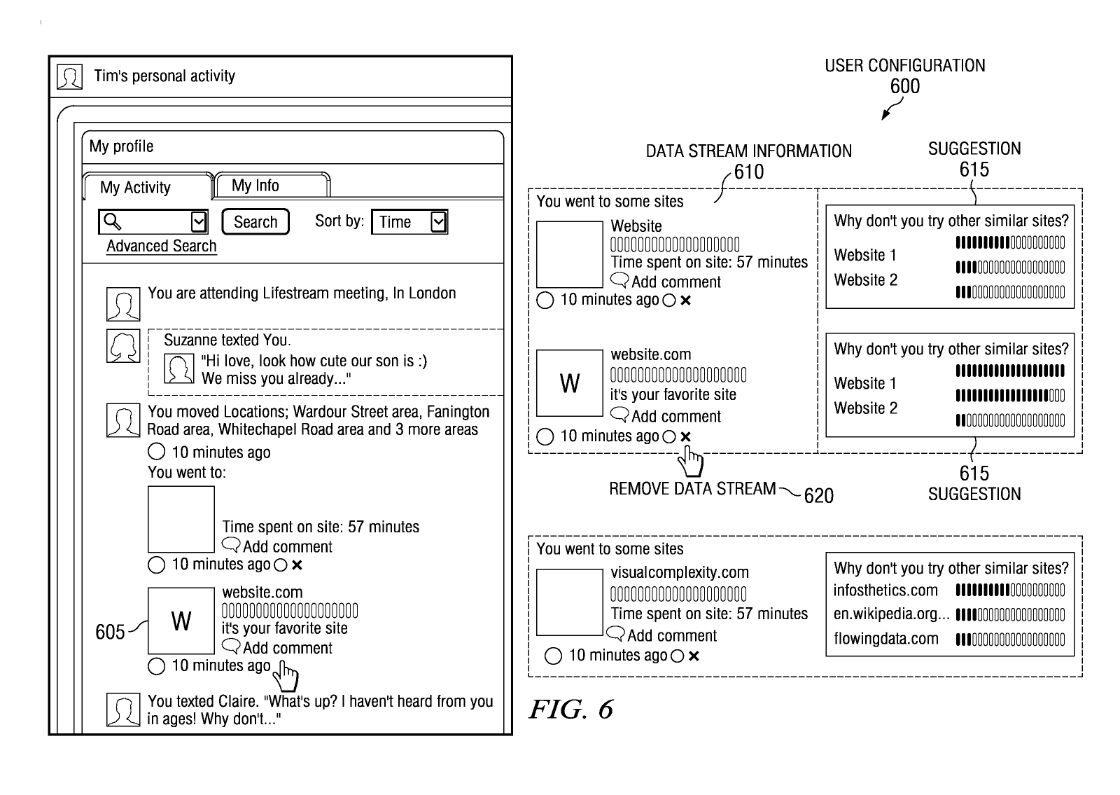

FIG. 6 is a screen view depicting an electronic device operating in accordance with an example embodiment. In an example embodiment, a user interface, such as user interface 420 of FIG. 4, is configured to display a user configuration 600 in, for example, a configuration view, such as configuration view 425 of FIG. 4.

In an embodiment, the user configuration displays at least one data stream 605. In an embodiment, the data stream 605 comprises data stream information 610. For example, the data stream information 610 comprises, time spent on the data stream, a comment, last access time, and/or the like. In an embodiment, the user configuration 600 may also display one or more suggestion, such as 615. Further, the user configuration 600 may allow a user to remove the data stream 620. In this way, the user configuration 600 facilitates creation of a user creation for data streams.

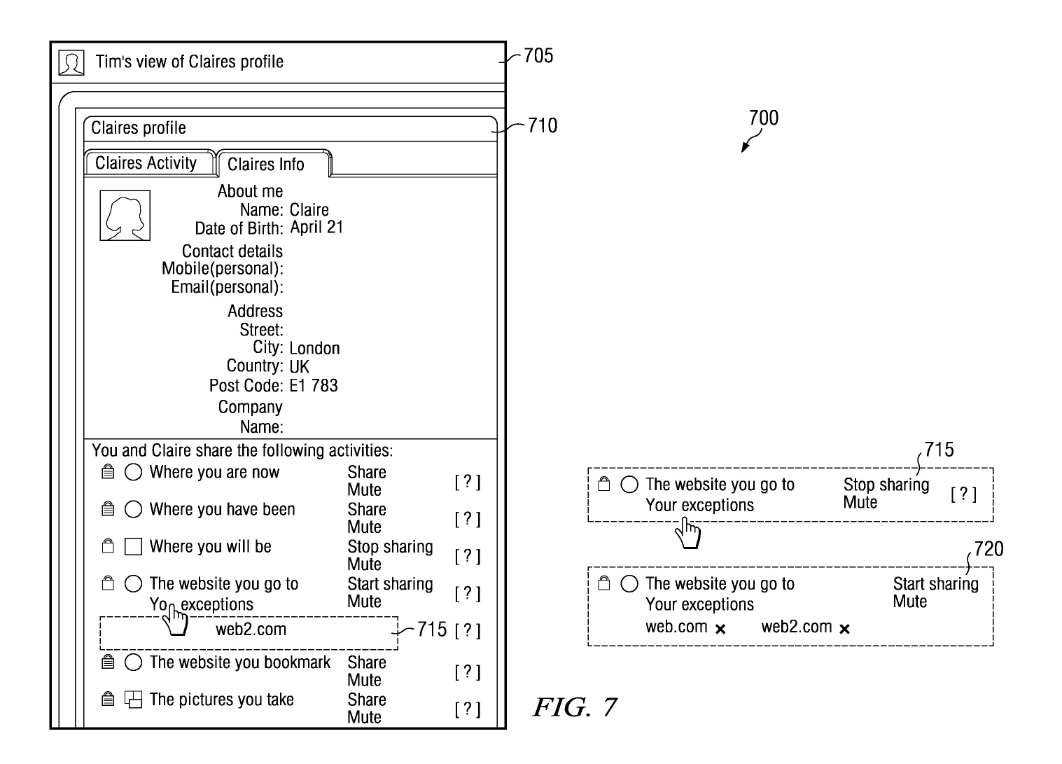

FIG. 7 is another screen view depicting electronic device operating in accordance with an example embodiment. In an example embodiment, a user interface, such as user interface 420 of FIG. 4, is configured to display a user configuration 700 in, for example, a configuration view 705, such as configuration view 425 of FIG. 4.

In an example embodiment, the configuration view 705 for a user allows creation and/or modification of the user configuration 700. In an example embodiment, the user configuration 700 display a second user's configuration view 710, e.g., a friend's user configuration. In such a case, the user may update the configuration view 705 by, for example, selecting a data stream option 715. In an example, the data stream option 715 may be a list of website exceptions. In an embodiment, a user may be allowed to stop sharing in the data stream option 715 or otherwise start sharing, for example, the second data stream option 720.

Without in any way limiting the scope, interpretation, or application of the claims appearing below, a technical effect of one or more of the example embodiments disclosed herein is receiving a flag, tag, and/or the like indicating to share or unshared a data stream. Another technical effect of one or more of the example embodiments disclosed herein is sharing a data stream. Another technical effect of one or more of the example embodiments disclosed herein is share data from a previously unshared data stream.

Embodiments of the present invention may be implemented in software, hardware, application logic or a combination of software, hardware and application logic. The software, application logic and/or hardware may reside on a computer, an electronic device or a service. If desired, part of the software, application logic and/or hardware may reside on a computer, part of the software, application logic and/or hardware may reside on an electronic device, and part of the software, application logic and/or hardware may reside on a service. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is

1. An apparatus, comprising:
at least one processor and at least one memory including computer program code, the at least one memory and the computer program code configured to, with the at least one processor, cause the apparatus to perform at least the following:
receive a user configuration related to a data stream from an electronic device; and
share or unshare the data stream with the electronic device based at least in part on the user configuration.

2. The apparatus of claim 1 wherein the user configuration is at least one of a tag or a flag associated with the data stream.

3. The apparatus of claim 1 wherein the at least one processor is further configured to classify the data stream as shared or unshared.

4. The apparatus of claim 1 wherein the at least one processor is further configured to share at least one additional data stream based at least in part on previously shared data streams.

5. The apparatus of claim 1 wherein the at least one processor is further configured to send a suggestion to a user based at least in part on previously shared data streams.

6. The apparatus of claim 1 wherein the at least one processor is further configured to share recorded data from a second data stream previously unshared.

7. A method, comprising:
receiving a user configuration related to a data stream from an electronic device; and
sharing the data stream with the electronic device based at least in part on the user configuration.

8. The method of claim 7 wherein the user configuration is at least one of a tag or a flag associated with the data stream.

9. The method of claim 7 further comprising classifying the data stream as shared or unshared.

10. The method of claim 7 further comprising sharing at least one additional data stream based at least in part on previously shared data streams.

11. The method of claim 7 further comprising sending a suggestion to a user based at least in part on previously shared data streams.

12. The method of claim 7 further comprising sharing recorded data from a second data stream previously unshared.

13. An apparatus, comprising:
at least one processor and at least one memory including computer program code, the at least one memory and the computer program code configured to, with the at least one processor, cause the apparatus to perform at least the following:
transmit a user configuration related to a data stream; and
receive the data stream based at least in part on the transmitted user configuration.

14. The apparatus of claim 13 wherein the user configuration is at least one of a tag or a flag associated with the data stream.

15. The apparatus of claim 13 wherein the at least one processor is further configured to receive a suggestion based at least in part on previously shared data streams.

16. The apparatus of claim 13 wherein the at least one processor is further configured to receive at least one additional data stream based at least in part on previously shared data streams.

17. A method, comprising:
transmitting a user configuration related to a data stream from an electronic device; and
receiving the data stream based at least in part on the transmitted user configuration.

18. The method of claim 17 wherein the user configuration is at least one of a tag or a flag associated with the data stream.

19. The method of claim 17 further comprising receiving a suggestion based at least in part on previously shared data streams.

20. The method of claim 17 receiving at least one additional data stream based at least in part on previously shared data streams.
